(19) United States
(12) Patent Application Publication
(10) Pub. No.: US 2008/0160358 A1
(43) Pub. Date: Jul. 3, 2008

(54) Method and System of Operating Molten Carbonate Fuel Cells

(76) Inventors: Filippo Parodi, Recco (IT); Barbara Bosio, Genova (IT); Elisabetta Arato, Genova (IT)

Correspondence Address: STETINA BRUNDA GARRED & BRUCKER, 75 ENTERPRISE, SUITE 250, ALISO VIEJO, CA, 92656, US

(21) Appl. No.: 11/794,185

(22) PCT Filed: Jan. 4, 2005
(86) PCT No.: PCT/EP2005/000028

§ 371 Date: Jun. 26, 2007

(51) Int. Cl. H01M 8/04; H01M 8/14

(52) U.S. Cl. 429/16; 429/22

(57) ABSTRACT

A molten carbonate fuel cell stack and a method of operating a molten carbonate fuel cell stack, which fuel cell comprises a porous anode, a carbonate-comprising matrix and a porous cathode, wherein the anode section is supplied with a hydrogenous gas and the cathode section is supplied with a gaseous mixture comprising oxygen and carbon dioxide, the fuel cell is operated at a temperature in a range of about 823-973 K, with the carbonate of the carbonate-comprising matrix being in a fluid state, oxygen and carbon dioxide are reacted at the cathode, yielding carbonate ions which move from the cathode to the anode generating an electric voltage between the anode and the cathode and an electrical current circulating in the external circuit and water that has been formed is led away from the fuel cell together with carbon dioxide, comprising sampling the temperature of inlet of the reactants, sampling the temperature of outlet of reactants, sampling the current density and voltage sampling the flow rate and gas composition of the inlet and outlet gases analyzing the sampled temperature, current density, voltage flow rates and gas composition, and regulating the inlet flow rate such as the pressure drop between inlet and outlet is below 20 mbar and the temperature in each element of a cell of the stack is below 973K.

### FIELD OF THE INVENTION

The present invention relates to fuel cells using molten carbonates as electrolyte, and, more particularly, to molten carbonate fuel cells where critical operating conditions, which can penalise electrochemical performance or cause material deterioration, are avoided by means of a proper design and operating optimisation, thereby improving their reliability.

### PRIOR ART

A fuel cell is a power generating apparatus for converting chemical energy into electrical energy using electrochemical reactions, and is highlighted as a new promising electrical energy source because it is an environmental friendly apparatus and has a high power-generating efficiency. A fuel cell has the characteristic of continuously generating power by supplying fuel through an oxidation reaction of hydrogen and a reduction reaction of oxygen in the air. Different kinds of fuel cells are under development at the moment. In particular, the technology of molten carbonate fuel cells (MCFCs) is now at the stage of scale up to commercialization and many developers have shown significant progress.

A molten carbonate fuel cell as distinct from other fuel cells utilizes molten carbonates as electrolyte, so that the operation is carried out at a high temperature of about 650° C. and the speed of the electrochemical reactions is quicker.

MCFCs are planar cells formed by a matrix filled with carbonates and coupled with two electrodes where the following reactions occur:

CO₂+½O₂+2e⁻→CO₃⁻⁻ (cathode) reaction 1

H₂+CO₃⁻⁻→H₂O+CO₂+2e⁻ (anode) reaction 2

H₂+½O₂→H₂O+heat+electric energy (total)

In addition, shifting reaction occurs on the anodic side:

CO+H₂O [symbol] CO₂+H₂. reaction 3

The fuel and the oxidant gas are fed separately, and the ceramic matrix prevents gas crossover and guarantees an adequate ionic conduction and electronic insulation. FIG. 1 shows the main components that form a single cell.

Unlike a low-temperature fuel cell, electrode reactions occur when the carbonate electrolyte is molten at a high temperature. For this reason, the oxidation-reduction reactions do not require an expensive noble catalyst, which usually is also very sensitive to poisons, so that a feature of MCFCs is the ability to use a wider range of fuels such as mixture also containing significant amount of carbon monoxide, coal gas, and fuel derived from biomass gasification.

Another feature is to anticipate a high efficiency above about 80% due to the utilization of electricity and waste heat.

The molten carbonate fuel cell has porous anode/cathode electrodes having a wide surface area for facilitating the smooth procedure of the oxidation-reduction reactions of hydrogen and oxygen. The molten carbonate impregnated in a porous ceramic placed between the porous anode/cathode electrodes functions as a shield preventing direct contact between the fuel consisting mainly of hydrogen and the oxidant consisting of oxygen and carbon dioxide, and a passage for guiding carbonate ions (C0₃⁻⁻) produced from the cathodic electrode to the anodic one.

A single cell forming the unit cell generates a low electromotive force of about 1 V, and is of no practical use. Such unit cells are stacked, with conductive separator plates placed between two adjacent unit cells, to constitute the power generating system. Specifically, the unit cell includes a pair of porous electrode plates, and an electrolyte plate consisting of alkali carbonate placed between these electrode plates. The separator plates electrically connect these unit cells, and provide the anodic electrode with a passage of a fuel gas and the cathodic electrode with a passage of an oxidant gas.

These stacked fuel cells require manifolds for distributing and collecting the reaction gases. The gases required for the reactions are supplied via inlet manifolds, and after passing through the electrodes, are discharged via outlet manifolds opposite the inlet manifolds. Each unit cell is provided with a wet seal formed by molten carbonates, in order to prevent the fuel and the oxidant from being mixed within the fuel cell. The body of the stacked fuel cells and the manifolds are also sealed together in order to prevent the reaction gases from leaking out.

In the case of the fuel cells, however, part of the energy contained in the fuel is converted into electrical energy, and the remainder is converted into heat. Accordingly, in the case of the stacked fuel cells, the thermal value varies according to the number of cells in the stack. The more the fuel cells are stacked, the more the thermal value is generated. Usually, a hot section is produced at the outlet of the gas.

This high temperature has an influence on the components of the fuel cell, i.e., the electrodes, the electrolyte and the separator plates. Specifically, there are some situations: change of the porous structure and evaporation of the liquid electrolyte, which are due to the high temperature; consumption of the electrolyte and deterioration of the separator plates, which are due to the increased corrosion of the metal separator plate; and leakage of the fuel gas, due to these causes. Therefore, the lifetime of the fuel cell is significantly reduced.

In order to suppress the production of the hot section, a method is widely used to cool it by overly supplying the oxidant gas mainly comprising air. The oversupply of air at the defined passage causes the pressure drops to be increased. The conventional molten carbonate fuel cell isolates the fuel from the oxidant gas by use of the electrolyte impregnated in the porous matrices. However, since the oversupply of the oxidant for suppressing the production of the hot section causes an overpressure within the cathodic passage, the oxidant gas can leak out due to the rupture of the wet seal or cross the matrices, thereby significantly shortening the life of the fuel cell body.

The working temperature also depends on the intensity of current generated. This is chosen as a compromise between high current-high specific power and low current-low specific power (which leads to lower temperatures).

With high current values or when high fraction of the fuel is consumed by electrochemical reactions (the so-called “fuel utilisation factor”) some problems may also occur. They are directly linked to the working conditions inside the electrodes that falls in the diffusion control regime, which causes a lowering of the cell performance.

Performance optimisation assumes particular importance in the case of molten carbonate fuel cells, in the highlighting of possible critical working conditions and the consequent choice of project features and operating conditions. Furthermore, this also suggests the development of a method for the optimisation of the process parameters, which allows operation at the highest efficiency in relation to the cell dimensions and number of elements forming the stack.

According to the state of the art, this necessity has been fulfilled by inserting inside the fuel cell particular sensors which determine the operating parameters and thus allow their adjustment. This does not ensure that in ranges which are far from those being measured the optimal conditions can be reached. Furthermore, not all the useful variables can be measured experimentally like for example the local current density. This kind of solution has the disadvantage of being very expensive, since it involves the installation of a certain number of sensors and measurement devices inside the cell elements and expensive data acquisition systems to manage the data. Additionally, considering the critical working conditions, those elements must be particularly accurate in order to ensure a continuous and secure functioning.

As an alternative to the experimental measurements, the use of commercial codes for the calculation and the simulation of the working conditions for a fuel cell might be considered. Unfortunately available commercial codes are limited by the degree of detail of the model, which has to take into consideration the various processes involved, and also by the calculation limits of the system itself when giving a solution to the model in real time.

### DISCLOSURE OF THE INVENTION

For these reasons, the present invention discloses a method, which allows verification of the chemical, physical and electrical conditions of every cell either in the design or in the working phase, based on the MCFC reference parameters and a detailed simulation model implemented by a calculation code. An automatic analysis method of the results obtained allows, starting from operative inputs, the optimisation of the project features and of the working conditions.

In particular, the reference parameters of the MCFC are internal resistance, polarisation resistance of the electrodes, concentration polarisation, open-circuit voltage and cross-over rates, while the simulation model uses a three-dimensional scheme based on local balances of mass, energy and momentum. By means of this model, it is possible to evaluate the average voltage or the current map relative to the cells, the thermal map of the solid, of the anodic and cathodic gases, the maps of composition and flow-rates of those gases and the value of the main parameters characterising the cell performance.

The settable operative conditions are the compositions, the flow-rates, the temperature and the pressure of the feeding gases, the average current density (or the cell voltage), the area, the number and the geometry of the cells. Those variables are defined on the basis of the expected cell performance and with respect to the maximum acceptable values for the following parameters: local solid temperature, pressure drop in the gas path channels, pressure difference in the anodic and cathodic compartments and current density/limiting current density ratio. This is obtained by means of a method set out in claim 1. Preferred embodiments of the methods are defined in the dependent claims 2 to 10. According to another embodiment it is disclosed a fuel cell according to claim 11, preferred embodiments are defined in dependent claim 12-13.

### FIGURES

FIG. 1—Scheme of a fuel cell.

FIG. 2—Modelling scheme of an MCFC stack.

FIG. 3—Flowchart for the calculation of the main features of each cell and the main iterative cycle for the temperature convergence of the different cells.

FIG. 4—Simplified flowchart of the calculation program MCFC-D3S© for a single cell (if average current density is fixed and co or cross-flow feeding is assumed).

FIG. 5—Simplified flowchart of the calculation program MCFC-D3S for a sub-cell (if average current density is fixed and co or cross-flow feeding is assumed).

FIG. 6: Map of the solid temperature calculated for a square stack fed by reformed natural gas [K].

FIG. 7: Map of the cathodic pressure drop for a square stack fed by reformed natural gas [mbar].

FIG. 8: Optimised map of the solid temperature calculated for a rectangular stack fed by reformed natural gas [K].

FIG. 9: Optimised map of the cathodic pressure drop calculated for a rectangular stack fed by reformed natural gas [K].

FIG. 10: Temperature map on the surface of a cell with co-flow feeding.

FIG. 11: Measured and calculated cell potentials (the potential of the central cells calculated without cross-over is about 692 mV)

FIG. 12: Measured and calculated cell temperatures (the temperatures of the central cells calculated without cross-over are all in the range 610-640° C.)

FIG. 13: Comparison of experimental and simulated data

FIG. 14: Cell voltage response to current density perturbation [mV]

FIG. 15: Cell solid temperature response to current density perturbation [K]

FIG. 16: Flow chart summarising the procedure used by the method

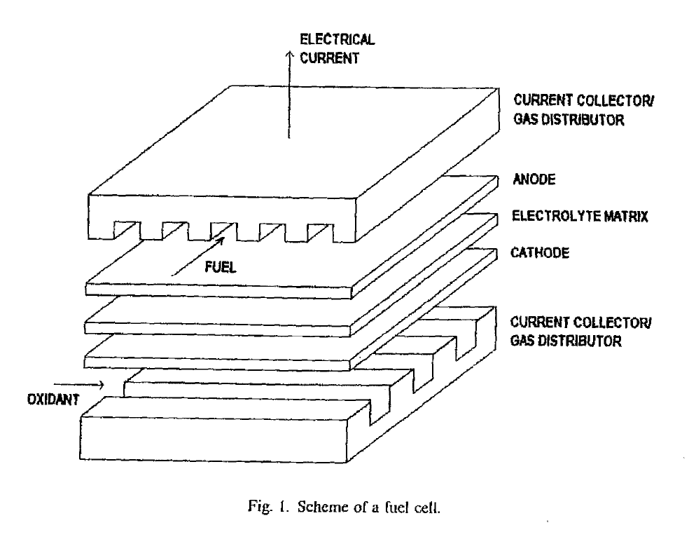

### DETAILED DESCRIPTION OF THE INVENTION

Molten carbonate fuel cells are reactors which, from an electrochemical point of view, have to be considered innovative since they convert the chemical energy of the fuel fed to the reactor directly into electrical energy. They are also characterised by high yields optimisation of the MCFC three steps have been used:

1. the evaluation of the experimental values of the MCFC which has to be tested;
2. the evaluation of the local chemical, physical and electrical conditions; the optimisation of the working conditions based on the results obtained and on specific operating constants.

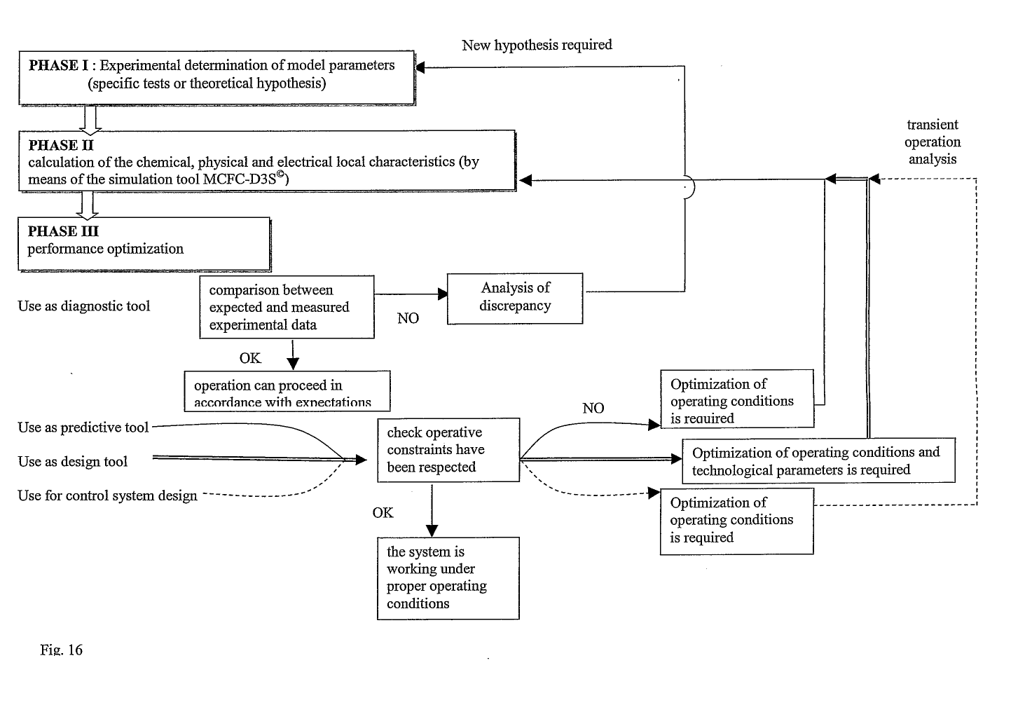

The procedure applied by the method is summarised in the flow chart on FIG. 16 and follows the scheme:

### Phase 1: Evaluation of the Experimental Values

The determination of the reference experimental values relating both to the kinetic and the electrochemical characteristics of the cell is carried out on a sample cell having the same constructional properties and undergoing the same storage and working conditions as the stacked cells.

Internal resistance R_{iR}: the method of its evaluation is described in patent application WO2003EP12590. The measurements are taken after the cell has completed the initial conditioning cycle and are repeated at 600, 625, 650, 675 e 700° C.

The results obtained are processed mathematically in order to identify the value of the coefficients cᵢᵣ (ohmic resistance of the contacts) and D (electrolite contribution) in the following equation:

R_{iR}=c_{iR}+D·e^{G/T}

where T=temperature [° K], Cᵢᵣ, D and G represent empirical parameters, typically 0.3 Ωcm²<Cᵢᵣ<0.8 Ωcm² and 5 10⁻⁵ Ωcm²<D<5 10⁻⁴ Ωcm² and D=6596° K.

Polarisation resistance of the electrodes R_{ηelectrode}: a characteristic potential/current curve at constant feed flow-rate and temperature is constructed.

From the slope of the curve, which corresponds to the polarisation of the electrodes, the coefficient A in the following semi-empirical expression is deduced:

$${R}_{η electrode} = \frac{A {e}^{\frac{B}{T}}}{{p}_{{O}_{2}}^{{β}_{O 2}}}$$

where T=temperature [K], A, B and β_{O2} are empirical parameters; typically, A is comprised between 3 10⁻⁶ Ωcm² Atm^{βO2} and 3 10⁻⁷ Ωcm² Atm^{βO2}, B=11400 K and β_{O2}=0.667.

Mass transport coefficient K_{cr}: constant feed flow-rate characteristic curves are extrapolated by increasing the working electric current up to the limiting value, where a sharp fall in performance occurs. Under these conditions, the limiting utilisation factor of a single reagent can be identified when the other reagents are fed to great excess. The mass transport coefficient is calculated using

$${K}_{Cr} = - \frac{{Q}_{r}^{0}}{L {c}_{r}^{0}} ln ( 1 - \frac{{u}_{r , lim}}{100} )$$

where Q⁰ᵣ=molar feeding flow rate for the reagent r per unit of length [mol/cm³ s], L=cell length [cm] and u_{r,lim}=utilisation factor-limit of the reagent r [%].

Cross-over: many tests are conducted at different cathode/anode flow-rate ratios by monitoring the output flow-rate in order to estimate a proportionality factor α between the possible flow of gas from one compartment to the other one and the pressure difference between those same compartments. In the project phase the method is applied by using values deriving from previous tests.

### Phase II: Evaluation of the Local Chemical, Physical and Electrical Conditions

The chemical, physical and electrical conditions for each stacked cell are calculated by means of a three-dimensional model based on the following starting hypothesis:
Every single cell is identified as the superimposition of an anode, a cathode, a matrix two current collectors (anodic and cathodic) and a bipolar plate; the temperature path through this cell-pack is assumed to be constant, so that the temperatures of each single component are undistinguishable;
The gases flow within the distributors according to a simulated preferential path, as passing through channels with constant transversal sections;
In the gas flow channels the temperature and speed profiles are completely developed;
In the transversal sections of the flow channels the gas composition and temperature are uniform;

From the electrical point of view each cell is assumed as an equi-potential surface;
The maps (of temperature, current etc.) are calculated by notionally dividing the cell into sub-cells with thermally conductive borders, so as to form a fine grid. The mesh is defined on the input data set;
In every sub-cell the temperature is assumed to be constant in the horizontal plane and the thermal exchange along the vertical axis between one cell and another one is estimated to be proportional to the temperature difference between corresponding sub-cells of adjacent cells;
The effect of radiation heat transfer is considered to be negligible;
The thermal exchanges between adjacent cells and between terminal cells and heating plates are considered only for conductive heat exchange;
The gas distribution along the vertical axis of the stack is assumed to be uniform;
Possible extra cathodes or extra anodes at the ends of the stack in order to minimize electrolyte migration through the external manifold gaskets are simulated as electrochemically inactive cells (patent application WO2003EP10589);
The electrical response of the stack to possible disturbances is considered instantaneous, while the thermal transient is calculated in relation to the thermal capacity of the system.

The theoretical model allows the calculation of the working conditions by steady-state or transient behaviour of single or piled MCFCs taking into consideration mass balances, momentum and energy as explained below.

Three MCFC feeding configurations are considered: cross, co and counter-flow.

Mass balance: In the electrodes, the following reactions take place:

CO₂+½O₂+2e⁻→CO₃⁻⁻ (cathode) reaction 1

H₂+CO₃⁻⁻→H₂O+CO₂+2e⁻ (anode) reaction 2

H₂+½O₂→H₂O+heat+electric energy (total)

the progression degree of which, allowing the mass balancing between the inlet and the outlet of each cell, is obtained from Faraday's Law. Besides the electrochemical reactions the water gas shift is also allowed for:

CO+H₂O [symbol] CO₂+H₂ reaction 3

which takes place in the anodic section where the gas composition is calculated by assuming that thermodynamic equilibrium has been reached.

The effect of a possible cross-over is calculated locally for every single cell in relation to the experimental parameter cited in phase I. The presence of cross-over effects involves also the evaluation of the gas composition and temperature in view of the following reactions:

H₂+½O₂→H₂O reaction 4

CO+½O₂→CO₂ reaction 5

These can take place at the anode or at the cathode depending on the cross-over direction. Combustion is assumed to be complete.

The balances are therefore the following:

| | | |
|---|---|---|
| Anodic Gas | $\frac{\partial {n}_{i}}{\partial x} = {r}_{i} where {r}_{i} = {\sum }_{j = 2}^{5} {v}_{i , j} {r}_{j} and {r}_{2} = J / {n}_{c} F$ | (6) |
| Cathodic Gas | $\frac{\partial {n}_{i}}{\partial y} = {r}_{i} where {r}_{i} = {v}_{i , 1} {r}_{1} + {\sum }_{j = 4}^{5} {v}_{i , j} {r}_{j} and {r}_{1} = {r}_{2}$ | (7) |
| Gas cross-over | q_{cross-over} = α\|pₐ − p_{c}\| | (8) |

### Energy Balance:

the anodic and cathodic temperature maps are calculated by means of thermal balances for each sub-cell.

They have the following expressions:

| | | |
|---|---|---|
| Anodic Gas | ${\sum }_{i} {n}_{i} {( C p )}_{i} \frac{\partial {T}_{a}}{\partial x} = {\sum }_{i} \frac{\partial {n}_{i}}{\partial x} {\int }_{Ta}^{Ts} {( C p )}_{i} {d T}_{a} + Sh ( {T}_{s} - {T}_{a} ) + {Q}_{cross - over}$ | (9) |
| | if pₐ < p_{c} Q_{cross-over} = −r₄ΔH₄ | |
| | else Q_{cross-over} = 0 | |
| CathodicGas | ${\sum }_{i} {n}_{i} {( C p )}_{i} \frac{\partial {T}_{c}}{\partial y} = {\sum }_{i} \frac{\partial {n}_{i}}{\partial y} {\int }_{Tc}^{Ts} {( C p )}_{i} {d T}_{c} + Sh ( {T}_{s} - {T}_{c} ) + {Q}_{cross - over}$ | (10) |
| | if pₐ > p_{c} Q_{cross-over} = −r₄ΔH₄ − r₅ΔH₅ | |
| | else Q_{cross-over} = 0 | |

The gas temperature is the approximate analytical solution of the differential equation by considering the flow-rates and the temperature of the solid on the sub-cell to be uniform.

This balance takes into consideration both the thermal exchange between solid and gas and the thermal contribution due to the elements taking part in the electrochemical reaction and which, in ordinary working conditions (Tₛₒₗ>T_{gas}) causes a lowering of the gas temperature for the elements which leave the gas in order to react in the electrode (H₂ at the anode, O₂ and CO₂ at the cathode) and a temperature increase of the gas associated with the reaction products enriching the gas (H₂O and CO₂ at the anode). In order to evaluate the thermal map of the solid, various different thermal contributions to each sub-cell from the adjacent sub-cells, from the anodic and cathodic gases, from the reactions taking place in the sub-cell itself and from the external environment must be considered.

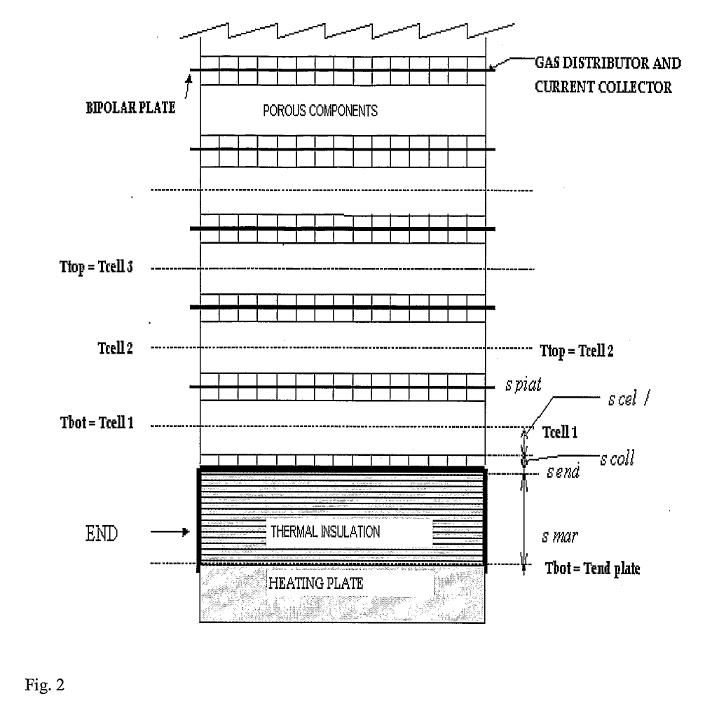

FIG. 2 shows a diagram of the stack, which is useful for understanding the model being described with respect to the estimation of the heat exchange along the vertical axis of the stack. Note that the possible presence of terminal heating plates is also allowed for.

The total thermal balance of the solid is as follows:

ρCₚsdT/dt=Sₐhₐ(Tₐ−Tₛ)+S_{c}h_{c}(T_{c}−Tₛ)+Q_{cond}+Q_{reac}+Q_{stack} (11)

for the dynamic version

Sₐhₐ(Tₛ−Tₐ)+S_{c}h_{c}(Tₛ−T_{c})=Q_{cond}+Q_{reac} (12)

for the steady-state version
where

$$\begin{matrix}{Q}_{cond} = {\sum }_{n}^{ } ( {s}_{n} {λ}_{n} ) ( \frac{{\partial }^{2} {T}_{s}}{\partial {x}^{2}} + \frac{{\partial }^{2} {T}_{s}}{\partial {y}^{2}} ) & ( 13 ) \\ {Q}_{reac} = {\sum }_{j = 1}^{3} {r}_{j} Δ {H}_{j} - VJ & ( 14 ) \\ {Q}_{condstack } = {K}_{top} ( {T}_{top} - {T}_{sol} ) + {K}_{bot} ( {T}_{bot} - {T}_{sol} ) & ( 15 )\end{matrix}$$

In the case of an internal cell in the stack:

T_{top/bot}=temperature of the adjacent cell above/below [K]

$$\begin{matrix}{K}_{top} = {K}_{bot} \\ = {( \frac{scel}{kcel} + \frac{spiat}{kacc} + \frac{2 \cdot hcoll}{kcoll} )}^{- 1} [ W / mK ] \\ t hermal resistances in series\end{matrix} \qquad ( 16 )$$

In the case of the top cell:

Ttop=temperature of the plate above [K]
Tbot=temperature of the adjacent cell below [K]

$${K}_{top} = {( \frac{scel}{2 \cdot kcel} + \frac{sen d}{kacc} + \frac{smar}{kmar} + \frac{hcoll}{kcoll} )}^{- 1} [ W / mK ] thermal resistances in series \qquad ( 17 )$$

Kbot=Kbot from (16)

In the case of the bottom cell:

Ttop=temperature of the adjacent cell above [K]
Tbot=temperature of the plate below [K]
Ktop=Ktop from (16)
Kbot=Kbot from (17)

The conductivity of the current collector is considered as a set of thermal resistances in parallel.

Kcoll=kacc·scoll·(ncan+1)[W/mK] (18)

As said above, it is also possible that extra-cathodes or extra-anodes are present at the ends of the stack (reservoirs) which minimise the electrolyte migration effects along the gasket of the external manifolds (patent application WO2003EP10589).

In this case, reservoirs are simulated as cells where electrochemical reactions do not occur, and only thermal effect is taken into account.

### Momentum Balance:

the gas pressure drops along the cell channels are calculated as:

$$\frac{\partial {P}_{a / c}}{\partial {x}_{a / c}} = - {K}_{a / c} \frac{{μ}_{a / c} {v}_{a / c}}{{d}^{2}} \qquad ( 19 )$$

The electrochemical performance is calculated iteratively by means of the cell potential as a function of the average current if the latter is given as input data or by calculating the current itself if the potential is given.

The electrochemical kinetics are calculated as follows:

$$\begin{matrix}V = E - RJ - {η}_{conc} \\ = E - ( \frac{A {e}^{\frac{B}{T}}}{{p}_{{O}_{2}}^{β}} + {c}_{iR} + D \cdot {e}^{\frac{G}{T}} ) \cdot J - \frac{{R}_{g} T}{nF} [ ln ( 1 - \frac{J}{{J}_{{H}_{2} , lim}} ) + \\ \frac{J}{{J}_{{H}_{2} , lim}} + ln ( 1 - \frac{J}{{J}_{C {O}_{2} , lim}} ) + \frac{J}{{J}_{C {O}_{2} , lim}} ]\end{matrix}$$

where the coefficients K_{cr}, A, B, c_{iR}, D and G are experimentally identified according to Phase I. As it frequently happens that in the same stack cells having the same structure behave differently, in order to make interpretation of the experimental data easier, the parameters of each cell can be identified in the input.

The calculation code for applying the described theoretical model is MCFC-D3S© and the subsequent updates. It is in Fortran language, has a main program and 19 subroutines and it calculates iteratively several dozen 4D vectors of more than 80 elements.

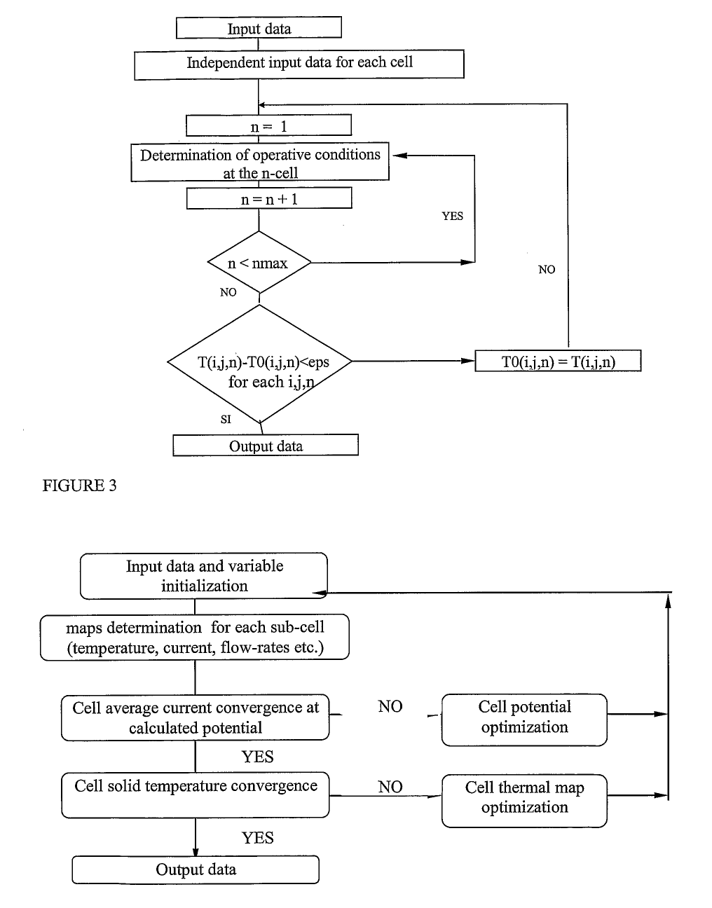

FIG. 3 shows the flow chart where the main part relating to the calculation of the main characteristics of each cell and the main iterative cycle for obtaining convergence on the temperature of the different cells can be seen.

The symbols are:

nmax=total number of cells (or packs containing a number of cells assumed under the same operating conditions in order to speed up the calculations)
i,j=coordinates indicating the position on the plane of a cell
T(i,j,n)=solid temperature calculated at point i,j of cell n
T0(i,j,n)=initialization solid temperature at point i,j of cell n
eps=error allowed in solid temperature convergence.

The code can run having the average current density as input value and then calculates the relative potential, or calculates the average current density starting from the potential value.

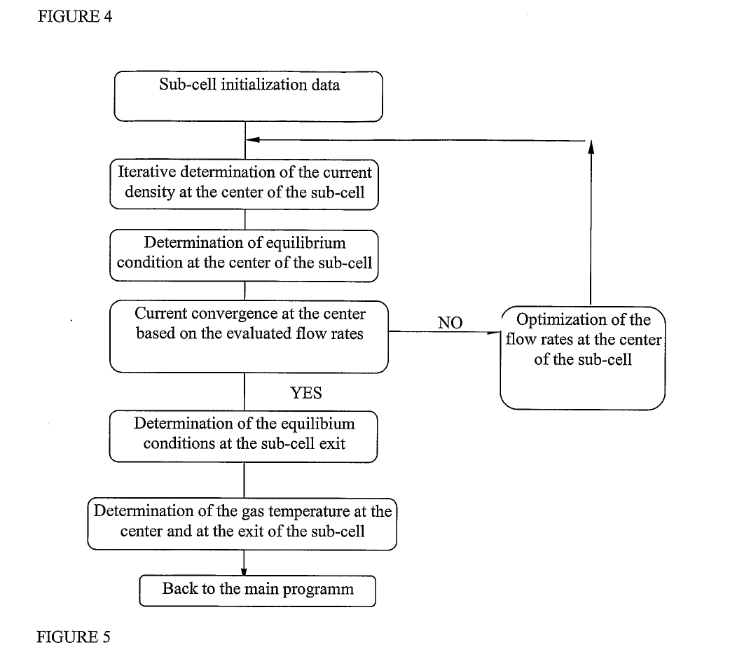

In the flow-chart in FIG. 4 the calculation starting from the current density is shown. It is possible to distinguish the main part relating to the calculation of the principal characteristics of each sub-cell and the two principal iterations to obtain the convergence first on the average cell current and then on the thermal map of the cell itself.

As it's foreseen the calculation of the MCFC local operating conditions assuming different feeding solutions, the differential equations of the model related to anodic and cathodic paths are written in the code taking account of the correct flow-rate direction as a function of the chosen option. In the case of counter-flow an additional iteration loop is considered for the inlet conditions of the cathodic gas, allowing the calculation along the anodic direction starting from the cathodic outlet conditions.

The calculation for each sub-cell can be set out as in FIG. 5. In the option where the cell potential is given as input value the algorithm is considerably simplified by the absence of the convergence loop on the potential.

The calculations requiring to be solved by iterative methods are developed as follows:
convergence of local current: predictor corrector with weighted average;
convergence of sub-cell current: predictor corrector;
convergence of cell potential: iterative optimisation method (similar to the tangent method);
convergence on the progression degree for the reactions: Newton-Raphson method;
convergence solid temperature: Landweber method.
temperature convergence along the vertical axis of the stack: predictor corrector
convergence of inlet cathodic conditions (only for counter-flow): predictor corrector with weighted average.

The thermal regime condition for each cell is calculated at each iteration along the stack as a function of the temperature of the adjacent cells as obtained in the preceding cycle.

The program offers the following calculation options:
To calculate operating conditions for cross, co or counter-flow feedings;
To calculate the stationary working conditions or transient operation
To calculate voltage at fixed current density or current density at fixed voltage;
To calculate the thermal map of every cell or to consider isothermal cells on the plane.
To consider in the anodic part only the electrochemical reaction or the electrochemical reaction together with the water gas shift reaction.
To use constant average values for the specific heat of the gases or to calculate them as a function of the temperature.
To identify the electrochemical kinetics by means of a global constant resistance or the local resistance described as a function of temperature and gas compositions, with or without taking into consideration the diffusion phenomena.
To calculate the working condition of each cell or, in order to shorten the running time of the program, to group the cells into different packs of consecutive cells for which the same working conditions are hypothesized and calculated.
To select the local and/or the global variables to be tracked as a function of the time, in the case of dynamic simulation.

### Input Data

### Operating Conditions

Anodic and cathodic inlet temperature [K]
Ambient temperature [K]
Anodic and cathodic inlet pressure [atm]

### Operating Current Density [A/cm²]

Top and bottom heating plate temperatures [K]
Anodic and cathodic inlet flow rates of each component [Nm³/h]

### Geometric Characteristics

Feeding type (cross, co or counter flow)
Stack cell number
Cell dimensions [cm]
Cell channel number [cm⁻¹]
Cell channel height [cm⁻¹]
Contact surface gas/solid ratio at anode and cathode
Thickness of porous components, bipolar plates, current collectors, thermal insulation [cm]

### Chemico-Physical Characteristics

Heat transfer coefficients [W/cm²K]
Mass transfer coefficients [cm/s]
Thermodynamic equilibrium correction factor for water shift reaction
Nusselt number
Pressure drop coefficients
Gas cross-over rate [Nm3/h mbar]
Conductivity of porous components, bipolar plates, current collectors, thermal insulation [W/cmK]
Kinetics parameters for electrochemical reactions

### Calculation Parameters

Finite difference subdivision number
Calculation options
(i.e. isothermal behaviour, simplified kinetics, diffusion model, no water gas shift reaction)
Maximum iteration number
Tolerances (i.e. current density and solid temperature convergence error)
Heat capacity of stainless steel, alumina, Ni, NiO, Li₂CO₃ and K₂CO₃ [cal·K⁻¹·mol⁻¹], Density of stainless steel, alumina, Ni, NiO, Li₂CO₃ and K₂CO₃ [kg/l], as well as porosity and molten carbonate filling degree of each component.

### Output Data

Stack cell voltage [V] and maps on each cell plane of:
solid temperature [K],
anodic and cathodic gas temperature [K],
current density [mA/cm²]
anodic and cathodic limiting current density [mA/cm²],
total electrical resistance [Ω*cm²],
ohmic resistance [Ω*cm²],
polarization losses [Ω*cm²],
concentration polarization losses [Ω*cm²],
thermodynamic voltage [V],
molar fractions of each component of the gas mixture at anodic side and cathodic side, molar flow rates of each component of the gas mixture at anodic side and cathodic side, water gas shift reaction conversion rate [Nm³/h],
pressure drops at anodic side and cathodic side [mbar],
pressure difference between anodic side and cathodic side [mbar].

These results are calculated at the initial working point as well as at some intermediate transient states up to the new final steady state condition, when dynamic simulation is carried out.

### Phase III: Performance Optimization

The results obtained via the calculation code allow optimisation of the operating conditions and therefore of the performance of the stacks.

The method, which is based on using the code, is an instrument for predictive and design, diagnostic and checking applications.

In this phase, whether the method is applied in the design phase or predictive terms to optimise working conditions, it is appropriate to bear in mind the operating requirements needed for optimum working of the MCFC stacks concerned:

A. Maximum local temperature: 973 K
B. Minimum local temperature: 853 K
C. Maximum difference in pressure between the anodic and cathodic compartments: 20 mbar
D. Maximum pressure drop along the anodic and cathodic compartments: 20 mbar
E. Uniformity of working conditions along the vertical axis of the stack.
F. Minimum cell operating potential: 0.6 V
G. Maximum dT/dt: 50° C./h
H. Maximum local J/Jlim: 0.9
I. Maximum fuel utilization factor (H₂+CO): 85%
J. Maximum utilization factor of the oxidant (CO₂): 56%

When in the following table, the use of the code indicates that the constraints are not respected, the method according to the invention point out the design and operational actions suggested to guarantee an optimal functioning of the system.

| NON- | | |
|---|---|---|
| RESPECTED | | |
| CONSTRAINT | ACTION | TYPE of ACTION |
| A | ↓ T inlet | Modification of operating |
| | | conditions |
| | ↑ cathodic flow-rate | Modification of o.c. |
| | ↓ current density | Modification of o.c. |
| B | ↑ T inlet | Modification of o.c. |
| | ↓ cathodic flow-rate | Modification of o.c |
| C If Pc > Pa | ↑ operating P | Modification of o.c. |
| | ↓ cathodic flow-rate | Modification of o.c |
| | ↓ cathode length | Modification of |
| | | geometric characteristics |
| D | ↓ flow rate | Modification of o.c. |
| | ↑ channel hydraulic | Modification of g.c. |
| | diameter | |
| | ↓ channel length | Modification of g.c. |
| | ↑ number of stacked cells | Design |
| | ↑ operating P | Modification of o.c. |
| E | Redefinition of thermal | Design |
| | dissipation | |
| F | ↓ Current density | Modification of o.c. |
| | Low V alarm | Control |
| G | Modification of the variations | Modification of o.c. |
| | in input settings | Control |
| H | ↓ current density | Modification of o.c. |
| | ↑ anodic flow rate | Control |
| | ↓ number of stacked cells | Design |
| I | ↓ current density | Modification of o.c. |
| | ↑ anodic flow rate | Control |
| | ↓ number of stacked cells | Design |
| J | ↓ current density | Modification of o.c. |
| | ↑ CO₂ flow rate | Control |
| | ↓ number of stacked cells | Design |

If the method is being used for a diagnostic application, comparison of the simulation results will be made with the experimental ones, in case of disagreement the following considerations may be taken into account:

| Variable that does not agree | Hypothesis |
|---|---|
| Temperature | Leakage |
| Tₛᵢₘ > Tₑₓₚ | Thermal dissipation |
| Temperature | Crossover |
| Tₛᵢₘ < Tₑₓₚ | |
| Potential | Feed gas composition different from |
| Vₛᵢₘ > Vₑₓₚ | the set-up |
| | Internal electrical dissipations |
| | Kinetics affected by secondary phenomena |
| | Crossover |
| Pressure losses along the | Channel obstruction |
| stacked cell DPₑₓₚ > DPₛᵢₘ | |
| Temperature distribution | Non-uniform gas distribution |
| on a cell or along the vertical | Crossover |
| axis of the stacked cells | Partial inhibition of the water shift |
| | reaction |

In conclusion, for the application of the method as a control instrument use of dynamic simulation allows the system's response times to corrective action to be forecast and therefore the time to restore safe working conditions.

### Example of Predictive, Diagnostic and Design Application

The calculation method described here can be advantageously used in a method that manages the working conditions of a MCFC stack, when its characteristics are known, optimising its functioning.

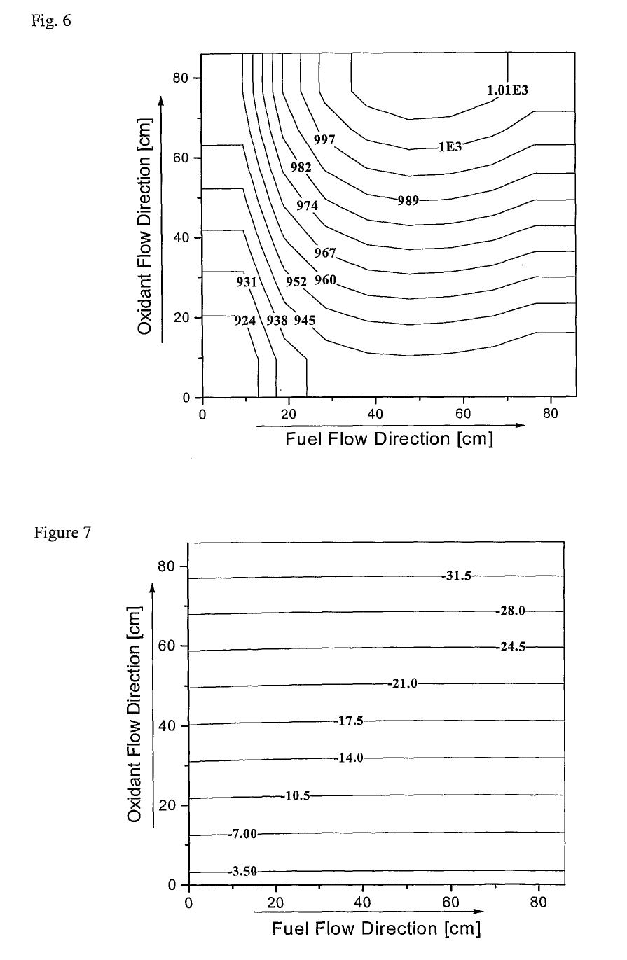

A stack of square planar cells of 0.75 m² fed with crossed flow with reformed natural gas attains excessively high local temperature values and pressure drops when the current density is greater than 1350 A/m². The setting up of these phenomena brings about a sharp reduction in performance and in power supplied, in that the cell material is damaged. By means of the simulation according to the invention the design and working parameters can be acted upon and the above-mentioned phenomena avoided by checking the temperature profiles and the values for the pressure drops to be calculated. For example, FIGS. 6 and 7 show the maps calculated for the temperature and the pressure drop of the cathodic gas at a reference current density of 1500 A/m² and at the working pressure of 3.5 Atm (fuel: 57.1% H2, 27% CO2, 14.3% N2, 1.6% H2O, total flow-rate 16.18 Nm3/h; oxidant: 7.2% CO2, 59.2% N2, 10% O2, 23.6% H2O, total flow-rate 243.14 Nm3/h). The simulation succeeds in calculating that the maximum temperature in the cell has reached 1018 K, when the maximum acceptable value is 973 K, and establishing that the maximum drop in flow-rate of the cathodic gas, 35 mbar, and the maximum difference in pressure to which the matrix is subjected, 34.9 mbar, are well above the maximum acceptable values of 20 mbar. The system reacts in the particular case by reducing the temperature of the gas entering the cell to the minimum permitted value of 853 K, then increasing the total flow-rate at the cathode, so that the air cools the stack itself. Nevertheless, it should be noted that this last operation is not feasible for the limit imposed on the maximum drop in flow-rate allowed on the cathodic side. Advantageously the system reacts by changing the geometry of the cell from square to rectangular shape with the side crossed by the cathodic gas shorter than the anodic side.

The system and the method according to the invention conduct and resolve a parametric analysis that identifies, the total area of the cell being the same, the appropriate length of the cathodic side to reduce the pressure drop and to avoid the formation of areas of overheating inside single cells.

The 20 mbar limit value for the pressure drop of the cathodic gas has been reached for lengths crossed by the cathodic gas of 67 cm. The system then reacts by reducing the cathodic side and increasing the anodic side so as to keep the temperature values and the pressure drop within the range that ensures maximum power supplied.

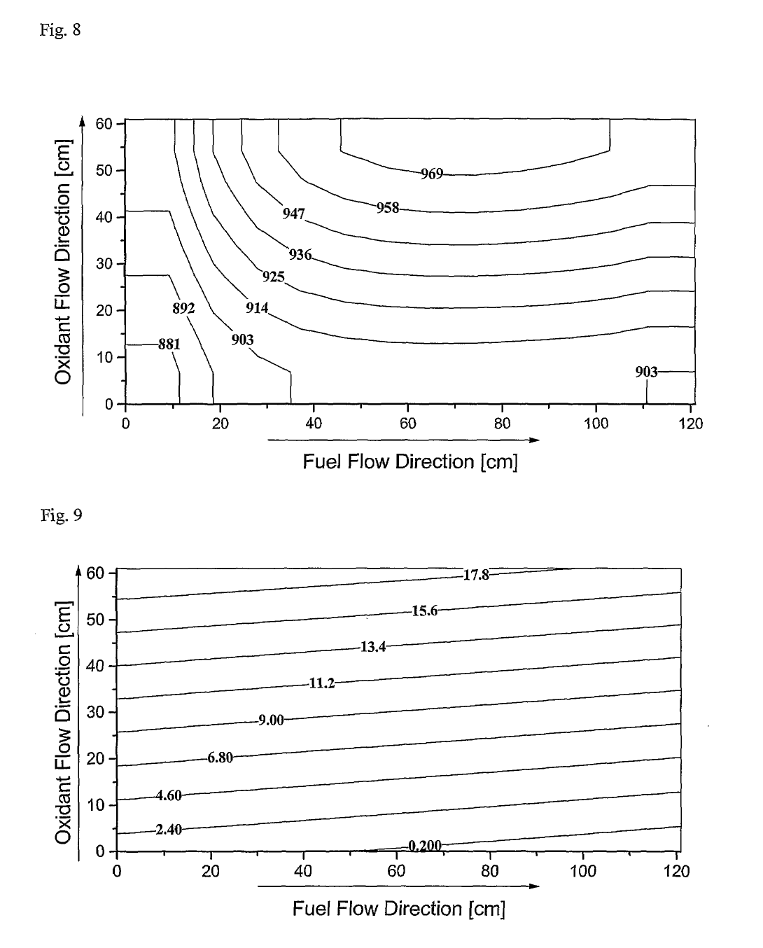

The method for controlling operating conditions using the simulation provided by the invention allows the designer to appreciate that the change in geometry, although it does not in itself affect the cell temperature, has allowed a reduction in temperature by providing for an increase of 20% in cathodic feed. The system provided by the invention calculates the maps of temperature and differences of pressure to which the matrix of the single cells presented in FIGS. 8 and 9 are subjected. The temperature spots with higher values, around 973 K, as also the maximum difference of pressure between anode and cathode, 18 mbar, and the loss of load at the cathode, 20 mbar, provide equality of power supplied within the operating limits.

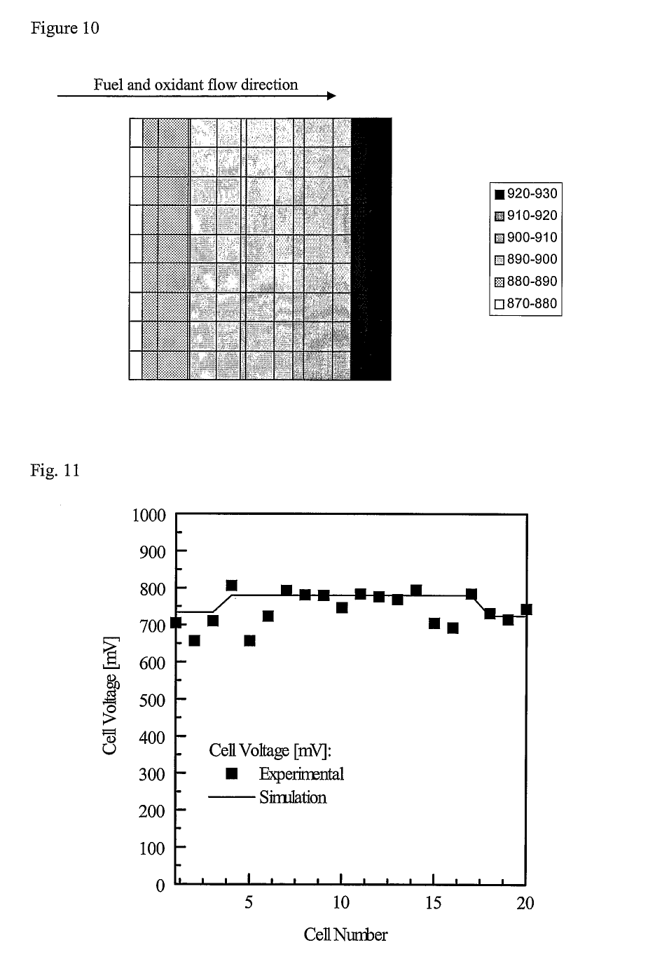

During the design of a fuel cell it can be useful to evaluate different geometries of inlet gas flow in order to optimize the temperature distribution and pressure losses inside a cell unit. The code MCFC-D3S© according to the invention allows checking the effective functioning conditions for system working at co-flow, cross-flow or counter-flow. For example FIG. 10 shows the results of a stacked fuel cell of 15 square cells of 0.75 m² surface fed with co-flow solution at a current density of 1350 A/m² and at a pressure of 3.5 atm, fuel flow-rate in Nm³/h: 4.45 CO₂, 14.69 H2, 4.97 H₂O, 40.04 N₂, oxidant flow-rate in Nm³/h: 26.33 CO₂, 5.26 H₂O, 141.71 N₂, 33.75 O₂.

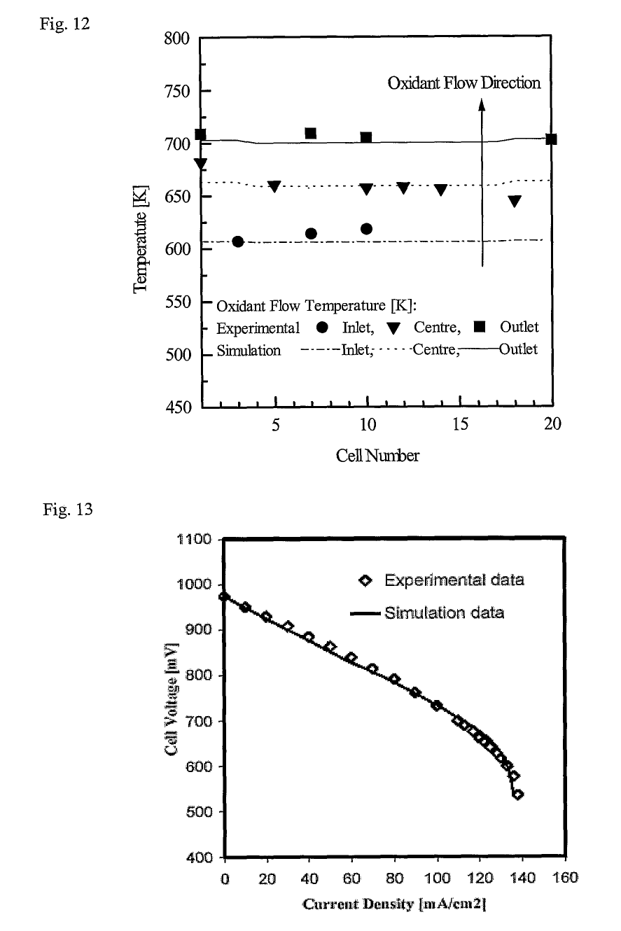

By assuring controlled pressure drops between anode and cathode avoids the occurring of detrimental phenomenon of cross-over. The reacting gas cross-over causes chemical combustion of the reagents through direct contact occurring simultaneously to the electro-chemical oxidisation, which implies significant negative thermal effects for the good working of the stack and lower yields. The simulation model according to the invention is able to calculate for each cell the temperature mapping of the solid and establish whether we are in the presence of the said phenomenon. FIGS. 11 and 12 show the experimental and calculated values according to the simulation model of the invention for cell potential and temperatures for a stack of 15 square cells of 0.75 m² surface operating with cross-flow where cross-over is present. The reference operating conditions are: operating pressure 3.5 atm, current density 132 mA/cm², anodic flow-rate in Nl/h: 0.32 CO₂, 1.02 H₂, 0.75 H₂O, 2.92 N₂, cathodic flow-rate in Nl/h: 2 CO₂, 10.37 N₂, 2.48 O₂. Thanks to the concordance between experimental and simulated values, only obtainable supposing the presence of cross-over, it's possible to analyze the staked cell behavior and evaluate the cross-over proportional to the difference in pressure between anode and cathode according to factor 6·10⁻⁶ mol/s m² Pa.

The method using the simulation confirms that both in the presence and in the absence of cross-over the maximum temperature is in the part of the cell where the gases exit nevertheless in the absence of cross-over a thermic jump is registered between the cell entrance and exit of about 77 K with an average temperature of about 908 K, while, in the presence of cross-over, there is an average cell temperature of about 932 K with a temperature gradient of no less than 90 K/cell length.

At the same time the simulation method used in the invention allows one to measure the maps of local electrical resistance.

As the temperature increasing due to cross-over is the reason for a lower electrical resistance, the first effect is an higher cell potential, in fact potentials of 0.87 V have been calculated as against 0.8 V in the absence of cross-over. The apparent performance improvement, higher potential and therefore greater power supplied, reduces the overall energy performance of transforming chemical energy into electrical energy, as chemical rather than electrochemical combustion of the reagents penalises electrical efficiency.

The simulation method applied to the process control of an MCFC stack allows the critical operating sizes of the stack to be estimated and the flow-rates, temperatures and operating pressures to be modified, so as to allow advantageous operation of the stack under the best chemical and electrical performance conditions.

The invention allows current distribution to be determined at cell level, knowledge of which becomes particularly important if high fuel usage values are being worked with, and therefore in conditions of limiting diffusion phenomena and possibly close to the limiting current value.

FIG. 13 shows the good level of agreement between experimental and simulated data relating to a characteristic curve taken up to the maximum current obtainable at atmospheric pressure, 650° C. and the following feed on each cell expressed in mol/s*10⁵: anode 1.4 CO₂, 2.3 H₂O, 16.6 N₂, 5.7H₂, cathode: 14.3 CO₂, 125 N₂, 15.1 O₂

In particular, the working of the cell has been studied at potential of 523 mV, i.e. in the last linear section of the characteristic curve, where the normal working conditions are apparently safe with respect to diffusion phenomena.

FIGS. 20 and 21 show the maps of the ratio between the local current density J and the limiting current density J_{r,lim} with respect to the reagent H₂ for the anode and CO₂ for the cathode.

From analysis of the maps obtained with the code it can be observed that part of the cell works under limiting operating conditions (J/J_{r,lim}→1). On the plane of the cell it is possible to identify both an anodic diffusion control near the fuel exit point and a cathodic one in the place where the fuel is fresh and the oxidant exhausted. The position of these regions depends precisely on the local concentrations of the reagents and on the current density map, parameters that are assessable using MCFC-D3S©.

Moreover, it is interesting to observe how the limiting operating conditions can also be reached when the polarisation concentration values (another parameter that can be assessed via the code) are significantly lower than the cell potential. For example in the case under discussion the maximum local polarisation value at cell level is only ⅕ of the cell potential, but it implies current density close to the limiting value.

Knowledge of the J/J_{r,lim} maps is very important for choosing safe working conditions for the whole cell, standard working points may in fact conceal significant diffusion phenomena that penalise performance.

This aspect is of particular importance when cells are stacked and form part of a plant whose re-circulation systems impose feed of much diluted flow-rates.

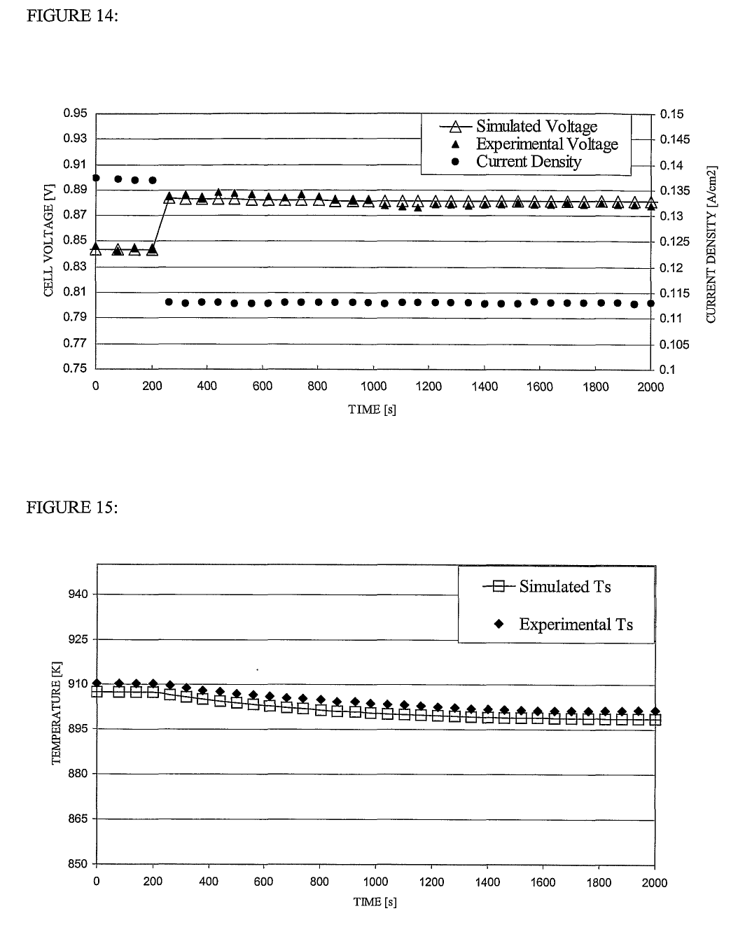

An example of use of the invention for checking the functioning of the cell in real time during the transients is shown in FIGS. 14 and 15, where the electrical and thermal values are reported for sudden change of the load. The comparison between experimental data and calculated values according to the invention confirms the reliability of the method according to the invention during transient functioning. The FIGS. 14 and 15 show, as result of a decrease of the current density of about 240 A/m², an instant increase of electrical potential of about 40 mV and a slower variation of temperature for both experimental and simulated data. In particular, the difference between measured and calculated values is lower of 4 degrees in terms of average temperature, as shown, while similar agreement is also obtained for local values either on the cell surface or each stack cell.

### List of Symbols

### Symbols Used on Eqq. (6), (7), (8), (9), (10)

F=Faraday's constant [C/mol]
J=current density [A/m²]
nᵢ=gas flow rate per length unit for the specie “i” [mol/m s]
nₑ=electrons transferred in reactions (1), (2)
p=pressure [Pa]
q_{cross-over}=cross-over flow rate [mol/s]
r=reaction rate [mol/m² s]
T=temperature [K]
x, y=cell co-ordinates [m]
α=cross-over parameter
ν=stoichiometric coefficient

### Symbols Used on Eqq. (11), (12), (13), (14), (15), (16), (17), (18)

T=temperature [K]
Tₜₒₚ=temperature of the stack element above the cell under calculation [K]
T_{bot}=temperature of the stack element below the cell under calculation [K]
Tₛₒₗ=temperature of the solid [K]
S=specific gas/solid interface area ratio
s=cell component thickness [m]
Cpᵢ=specific heat [J/mol K],
h=heat transfer coefficient gas-solid [W/m² K],
λ=porous component thermal conductivity [W/m K],
Q=thermal power density [W/m²]
ΔH=enthalpy variation [J/mole],
r=reaction ratio [moli/s],
scel=thickness porous elements [m]
kcel=conductivity of the cell porous elements [W/m K]
spiat=thickness by-polar plate [m]
kacc=steel thermal conductivity [W/m K]
kcoll=current collector thermal conductivity [W/m K]
hcoll=thickness gas distributors/current collectors [m]
scoll=steel thickness distributors/collectors [m]
ncan=number of passageways per length unit [m⁻¹]
send=end plate thickness [m]
smar=thickness marinite plates [m]
kmar=marinite thermal conductivity [W/m K]
ρ=cell density [mol/m³]

### Symbols Used on Eq. (19)

d=passageways height [m]
K=cell geometry, materials and flow regime coefficient
P=pressure [Pa]
x=passageways coordinate
v=gas velocity [m/s]
μ=gas viscosity [Pa s]

### Symbols Used on Eq. (20)

E=Nernst potential [V]
F=Faraday constant [C mol⁻¹]
J_{r,lim}=limiting current density for the reactant r [A/m²]=nFK_{cr}xᵣ
K_{cr}=transport coefficient for the reactant r (see at phase I)
n=electrons transferred in reactions (1), (2)
R=local resistance [Ωm²]
R_{g}=gas constant [J mol⁻¹K⁻¹]
T=temperature [K]
xᵣ=local molar fraction of reactant r
V=cell potential [V]
η_{conc}=concentration overvoltage [V]

### Index

a=anode
c=cathode
i=chemical species
j=reaction number
n=component
_{iR}=internal resistance

1. A method of operating a molten carbonate fuel cell stack, wherein each fuel cell of the stack comprises a porous anode, a carbonate-comprising matrix and a porous cathode, wherein the anode section is supplied with a hydrogenous gas and the cathode section is supplied with a gaseous mixture comprising oxygen and carbon dioxide, the fuel cell is operated at a temperature in a range of about 823-973 K, with the carbonate of the carbonate-comprising matrix being in a fluid state, oxygen and carbon dioxide are reacted at the cathode, yielding carbonate ions which move from the cathode to the anode generating an electric voltage between the anode and the cathode and an electrical current circulating in the external circuit, and water that has been formed is led away from the fuel cell together with carbon dioxide, comprising sampling the temperatures and pressures of the reactants at the inlet and at the outlet, sampling the current density and voltage, sampling the flow rate and gas composition of the inlet and outlet gases, analyzing the sampled temperature, current density, voltage, flow rates and gas composition, and regulating the inlet flow rates of the anodic and/or cathodic gas, characterized in that said analyzing step comprises:
a. subdividing each cell of the fuel cell stack into sub cells;
b. determining the initialization solid temperature and the error allowed in solid temperature convergence;
c. calculating the local temperature mapping in each cell of the fuel cells stack by determining for each sub-cell of a fuel cell a first temperature; repeating the routine of calculating the temperature if the difference between the calculated and initialization temperature is above the error allowed in solid temperature convergence, by first setting the initialization temperature equal to the calculated temperature;
d. comparing the produced data with a previously threshold value of temperature to determine the proper dosage of anodic and cathodic gases; and
regulating the inlet flow rates of the anodic and/or cathodic gas such that in each element of a cell of the stack the pressure drop between inlet and outlet is below 20 mbar and the temperature is within the operating range.

2. The method according claim 2 wherein the step of regulating the inlet flow of the anodic or cathodic gas maintains the local temperature in each cell of the stack between 923 and 973 K.

3. The method according claims 1-2 wherein the input temperatures of the anodic or cathodic gas are regulated between 823 and 973 K, preferably 853 and 873 K.

4. The method according claims 1-3 wherein said analyzing step before the cell solid temperature convergence further comprises:
determining a threshold value of the limiting current density and of the cell voltage,
calculating the current density mapping in each element of the a cell of the stack and the cell's average current density,
comparing the produced data with a previously determined threshold value of limiting current density to determine the proper utilisation factor, and
regulating the average current density in order to keep the cell voltage above the threshold value.

5. The method according claims 1-4 wherein said analysing step further comprises:
calculating the current density mapping in each element of the a cell of the stack and the cell's average current density
comparing the produced data with a previously determined threshold value of limiting current density to determine the proper utilisation factor, and
regulating the average current density in order to keep the maximum temperature below the threshold value.

6. The method according claims 1-5 wherein the cell potential is above 0.6V.

7. The method according claims 1-6 wherein said analyzing step further comprises:
calculating the current density mapping in each element of the a cell of the stack,
comparing the produced data with a previously determined threshold value of current density, and
regulating the cell geometry of the anodic and cathodic electrode to maintain the current density below the threshold value.

8. The method according claims 1-7 wherein the electrochemical reaction kinetics is defined by the formula
$$\begin{matrix}V = E - RJ - {η}_{conc} \\ = E - ( \frac{A {e}^{\frac{B}{T}}}{{p}_{{O}_{2}}^{β}} + {c}_{iR} + D \cdot {e}^{\frac{G}{T}} ) \cdot J - \frac{{R}_{g} T}{nF} [ ln ( 1 - \frac{J}{{J}_{{H}_{2} , lim}} ) + \\ \frac{J}{{J}_{{H}_{2} , lim}} + ln ( 1 - \frac{J}{{J}_{C {O}_{2} , lim}} ) + \frac{J}{{J}_{C {O}_{2} , lim}} ]\end{matrix}$$
where the coefficients K_{cr}, A, B, c_{iR}, D and G are experimentally determined.

9. The method according claims 1-8 wherein the computer program code MCFC-D3S© has been used.

10. A computer-readable medium encoded with a computer code for directing a computer processor to provide data from a molten carbonate fuel cell stack of claim 1 comprising the temperatures and pressures of the reactants at the inlet and at the outlet, the current density and voltage, the flow rate and gas composition of the inlet and outlet gases, analyzing the sampled temperature, current density, voltage, flow rates and gas composition, to a computer operator system, said program code comprising:
subdividing each cell of the fuel cell stack into sub cells;
determining the initialization solid temperature and the error allowed in solid temperature convergence;
calculating the local temperature mapping in each cell of the fuel cells stack by determining for each sub-cell of a fuel cell a first temperature; repeating the routine of calculating the temperature if the difference between the calculated and initialization temperature is above the error allowed in solid temperature convergence, by first setting the initialization temperature equal to the calculated temperature;
comparing the produced data with a previously threshold value of temperature to determine the proper dosage of anodic and cathodic gases; and
calculating the input value for regulating the inlet flow rates of the anodic and/or cathodic gas such that in each element of a cell of the stack the pressure drop between inlet and outlet is below 20 mbar and the temperature is within the operating range.

11. The computer-readable medium according claim 10 wherein in said program code before the cell solid temperature convergence analysis further comprises:
determining a threshold value of the limiting current density and of the cell voltage,
calculating the local current density mapping in each element of the a cell of the stack and the cell's average current density,
comparing the produced data with a previously determined threshold value of limiting current density to determine the proper utilisation factor, and
regulating the average current density in order to keep the cell voltage above the threshold value.

12. The computer-readable medium according claims 10-11 wherein said program code further comprises:
calculating the current density mapping in each element of the a cell of the stack and the cell's average current density
comparing the produced data with a previously determined threshold value of limiting current density to determine the proper utilisation factor, and
regulating the average current density in order to keep the maximum temperature below the threshold value.

13. The computer-readable medium according claims 10-12 wherein said program code further comprises:
calculating the current density mapping in each element of the a cell of the stack,
comparing the produced data with a previously determined threshold value of current density, and
regulating the cell geometry of the anodic and cathodic electrode to maintain the current density below the threshold value.

14. The computer-readable medium according claims 10-13 wherein the computer program code is MCFC-D3S©.
